(19) United States
(12) Patent Application Publication
(10) Pub. No.: US 2012/0031518 A1
(43) Pub. Date: Feb. 9, 2012

(54) NOVEL DESIGNS AND ASSEMBLY METHODS FOR CONDUIT USED IN HARNESSING HYDROKINETIC ENERGY

(75) Inventors: Gregory S. Smith, Poway, CA (US); Mark Rydell Cosby, Goshen, IN (US); Roderic Alan Schlabach, Goshen, IN (US)

(73) Assignees: LUCID ENERGY TECHNOLOGIES, LLP, Goshen, IN (US); NORTHWEST PIPE COMPANY, Vancouver, WA (US)

(21) Appl. No.: 12/849,764

(22) Filed: Aug. 3, 2010

(51) Int. Cl. F16L 55/00; B23P 11/00

(52) U.S. Cl. 138/108; 29/428

(57) ABSTRACT

A novel conduit design is disclosed. The conduit includes a cylindrical body having defined therein a first aperture and a second aperture, wherein the first aperture is designed to receive a shaft of a turbine and the second aperture is sufficiently large to facilitate ingress or egress of a probe through the second aperture, and wherein the second aperture is located a distance away from the first aperture such that when a turbine is disposed through the first aperture, an entry by a probe into the cylindrical body through the second aperture is not prevented by presence of the turbine.

### FIELD OF THE INVENTION

The present invention relates generally to pipes useful for harnessing hydrokinetic energy. More particularly, the present invention relates to novel designs and assembly methods for pipes, which allow for easy inspection and installation of turbines useful for harnessing hydrokinetic energy.

### BACKGROUND OF THE INVENTION

Hydrokinetic energy refers to the generation of energy from the flow, current or velocity of water. This type of energy is different from hydroenergy, which traditionally refers to power generated using dams (impoundment or run-of-river). Since hydrokinetic energy relies on the velocity of water, these energy systems can be placed into sources of flowing water with minimal infrastructure or environmental impacts. As a result, hydrokinetic power is considered cutting-edge waterpower.

To harness hydrokinetic energy, typically turbines operate in rivers, oceans and tidal settings. By way of example, in rivers, turbines can be installed for applications that harness energy from such settings as in-stream, free-flow, open-river or hydrokinetic run-of-river. As other examples, in ocean and tidal settings, turbines harness ocean power and tidal power, respectively.

These turbines may be loaded onto a barge, which is well equipped with cranes to facilitate the raising and lowering of individual turbines and power generating units that accompany them. In other examples, these turbines may be integrated into an in-pipe hydro-electric power generator.

Unfortunately, whether a barge or an in-pipe hydro-electric power generator is used, the current designs and methods of harnessing hydrokinetic energy suffer from drawbacks. By way of example, during operation, the turbine typically undergoes fouling and clogging by bio-growth, debris, sediment, and ice that is dragged by the flowing water. As expected, this results in reduced flow through the turbine, increased head losses and hydrostatic forces. To prevent or minimize such undesired consequences maintenance of the turbine is periodically conducted. The frequency of maintenance depends on, among other things, the amount of fouling and clogging agents present in the water flowing through the turbine. Regardless of the number of times maintenance is carried out, each time maintenance is deemed necessary, a significantly heavy turbine, i.e., typically weighing between about 0.5 tons and about 10 tons, is lifted up and removed from the water flow path. In most instances, the turbine is transported to a maintenance facility. Maintenance, therefore, not only represents a time-consuming and arduous task, but also requires extensive equipment (e.g., cranes and trailers). Furthermore, it is important to be very careful when moving such heavy equipment that the pipe or some portion of the turbine is not damaged because repair or permanent damage translates into additional costs.

What are therefore needed are designs and assembly methods for pipes, which allow for easy inspection and maintenance of turbines useful for harnessing hydrokinetic energy.

### SUMMARY OF THE INVENTION

In view of the foregoing, this invention provides designs and assembly methods for pipes, which allow for easy inspection and maintenance of turbines useful for harnessing hydrokinetic energy.

In one aspect, the present invention provides a conduit. The conduit includes a cylindrical body having defined therein a first aperture and a second aperture, wherein the first aperture is designed to receive a shaft of a turbine and the second aperture is sufficiently large to facilitate ingress or egress of a probe through the second aperture, and wherein the second aperture is located a distance away from the first aperture such that when the shaft of the turbine is disposed through the first aperture, an entry by a probe into the cylindrical body through the second aperture is not prevented by presence of the turbine. The second aperture is defined by an opening in a cylindrical body perpendicularly disposed on the conduit and protruding outward and the opening is a flanged opening. Inventive conduits of the present invention may further include a generator and a coupling, wherein the coupling serves as an interface between the shaft of the turbine and a shaft of the generator.

In accordance with one embodiment of the present invention, the first aperture has a diameter that is between about 2 inches feet and about 6 inches. In preferred embodiments of the present invention, however, the diameter is between about 2 inches and about 4 inches. Similarly, in one embodiment of the present invention, the second aperture has a diameter that is between about 2 feet and about 3.5 feet, but preferably has a diameter that is between about 2.5 feet and about 3.5 feet. The distance between the first aperture and the second aperture may be between about 2 feet and about 60 feet, but is preferably between about 4 feet and about 10 feet. The cylindrical body may have a diameter that is between about 2.5 feet and about 10 feet.

The turbine may be any one of spherical turbine, helical turbine, troposkein turbine, and circular-, square- or rectangular-shaped turbine. The probe may be a human, a motor-driven object or a remotely controlled object. In preferred embodiments, inventive conduits further include a frame assembly that is mounted on the conduit and disposed above the first aperture, and the frame assembly is designed to secure a generator above the turbine when the turbine is disposed through the first aperture. In certain preferred embodiments, the inventive conduits include a cover which covers the second aperture. The first aperture may be located upstream from the second aperture, but is preferably located located downstream from the second aperture.

In one embodiment of the present invention, inventive conduits include a first block, a first seal, and a first bearing that are disposed near first aperture to secure the turbine at a first location that is adjacent the first aperture. In certain embodiments of the present invention, inventive conduits also include a third aperture disposed opposite to the first aperture such that the shaft of the turbine passes through both the first aperture and the third aperture. Inventive conduits may further include a second seal, a second bearing and a second block to secure the turbine at a second location that is adjacent the third aperture.

In another aspect, the present invention provides a method of assembling a conduit capable of generating power. The method includes: (1) obtaining a cylindrical body having defined therein a first aperture and a second aperture; (2) introducing a turbine through the second aperture; and (3) displacing the turbine inside the conduit towards the first aperture such that a central axis of the turbine, which is capable of receiving a shaft, aligns with the first aperture.

In accordance with one embodiment of the present invention, in the above-mentioned step of obtaining, the second aperture is located on the cylindrical body a distance away from the first aperture such that an entry by a probe into the cylindrical body through the second aperture is not prevented by presence of the turbine.

Inventive methods may further include a step of covering the second aperture with a cover (e.g., blind flange). Furthermore, the step of introducing may include disposing a turbine that is any one of spherical turbine, helical turbine, troposkein turbine, and circular-, square- or rectangular-shaped turbine.

In preferred embodiments, inventive methods further include installing a frame assembly that is mounted on the conduit and disposed above the first aperture. This embodiment may further still include securing a generator using the frame assembly above the turbine.

The cylindrical body, implemented in the inventive methods, may have defined therein a third aperture and preferred embodiments of the inventive methods may include: (1) passing the shaft of the turbine through the first aperture and the third aperture; and (2) securing the shaft of the turbine near the first and the third apertures to prevent substantial lateral displacement of the turbine.

The construction and method of operation of the invention, however, together with additional objects and advantages thereof will be best understood from the following descriptions of specific embodiments when read in connection with the accompanying figures.

### BRIEF DESCRIPTION OF THE DRAWINGS

FIG. 1A shows a conduit, according to one embodiment of the present invention, having defined therein a first aperture and a second aperture.

FIG. 1B shows a conduit, according to an alternative embodiment of the present invention, having defined therein three apertures and including a flanged inlet and a flanged outlet.

FIG. 2A shows a side view of an in-conduit hydroelectric power generator, according to one embodiment of the present invention, which has incorporated into it the conduit of FIG. 1B.

FIG. 2B shows a perspective view of the in-conduit hydroelectric power generator shown in FIG. 2A.

FIG. 2C shows an inline view of a flow path of water inside the in-conduit hydroelectric power generator shown in FIG. 2A.

FIG. 2D shows a top view of the in-conduit hydroelectric power generator shown in FIG. 2A.

### DETAILED DESCRIPTION OF THE PREFERRED EMBODIMENTS

In the following description numerous specific details are set forth in order to provide a thorough understanding of the present invention. It will be apparent, however, to one skilled in the art that the present invention may be practiced without limitation to some or all of these specific details. In other instances, well known process steps have not been described in detail in order to not unnecessarily obscure the invention.

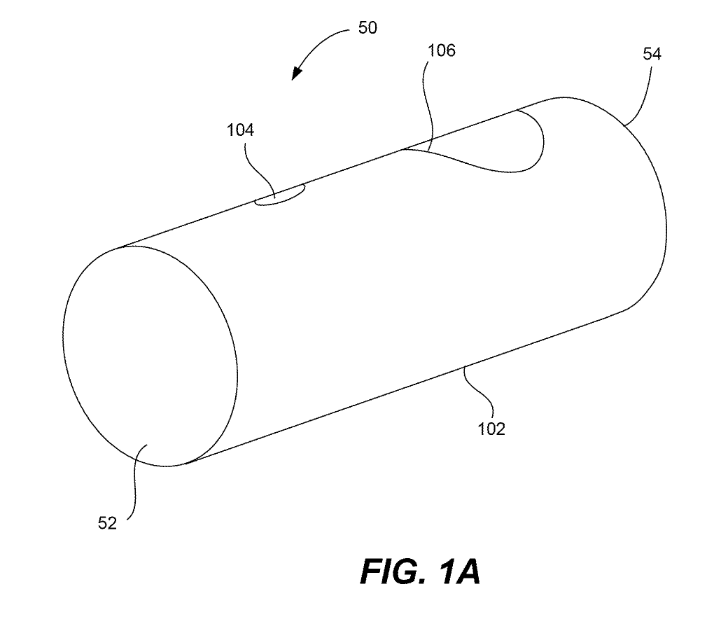

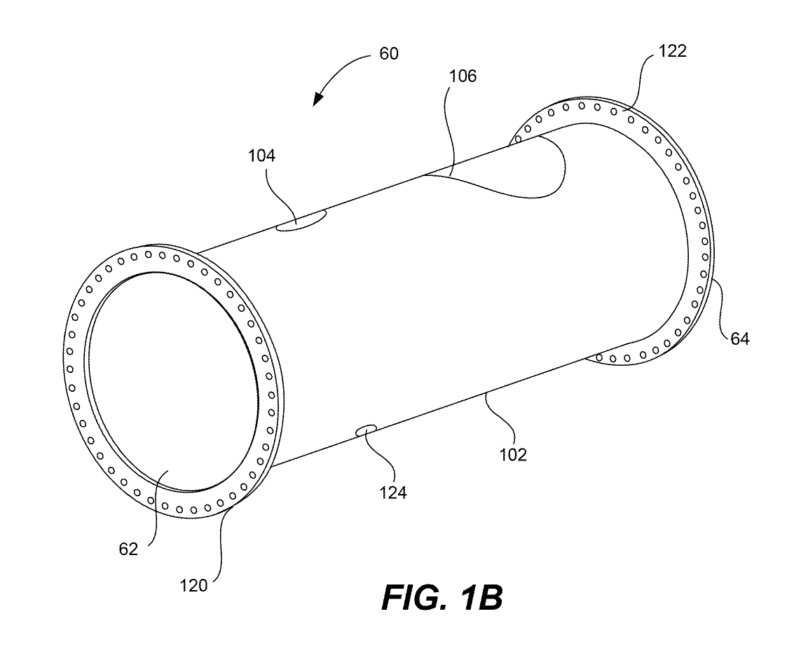

FIG. 1A shows a conduit 50, according to one embodiment of the present invention, which includes a cylindrical body 102 have defined therein two apertures, i.e., a first aperture 104 and a second aperture 106. The conduit is designed to provide a flow path for water through an inlet 52 and an outlet 54. Conduit 50 is made from any rigid material which is capable of withstanding water of turbulent flow profile. Preferably, however, conduit 50 is made from steel, concrete, plastic, high density polyethylene, or any composite material capable of sustaining internal pressure and flow in the cylindrical body 102. Cylindrical body 102 may have a diameter that is between about 2.5 feet and about 10 feet. In preferred embodiments, however, inventive conduits have a diameter that is between about 3 feet and about 8 feet.

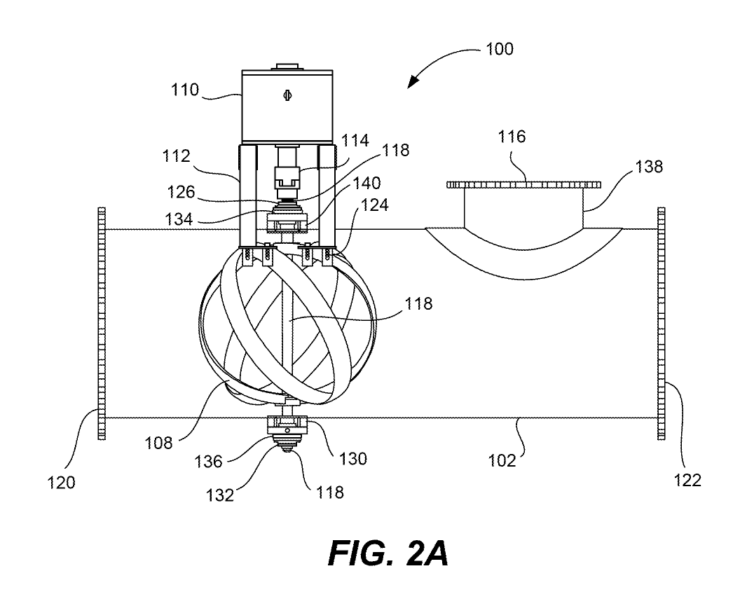

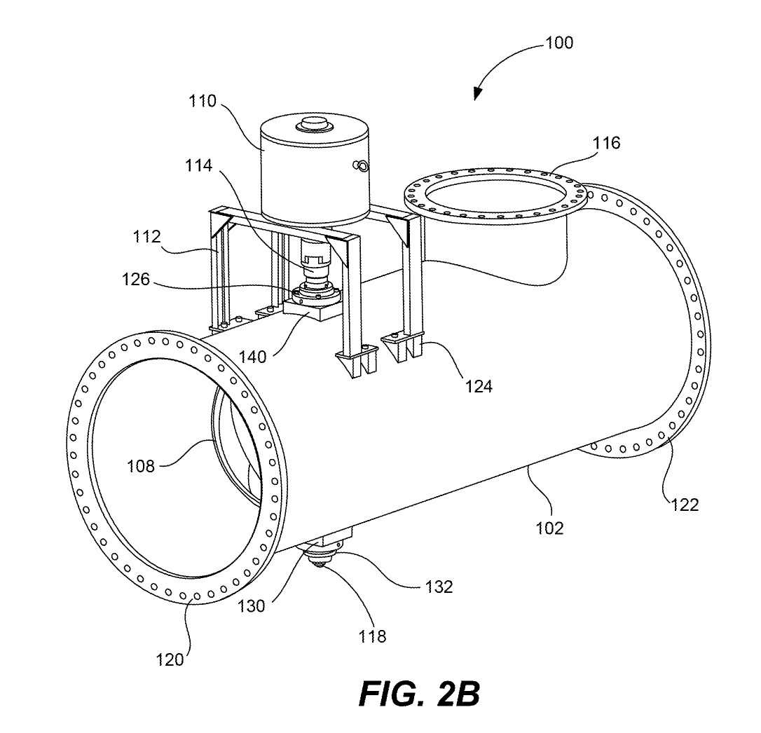

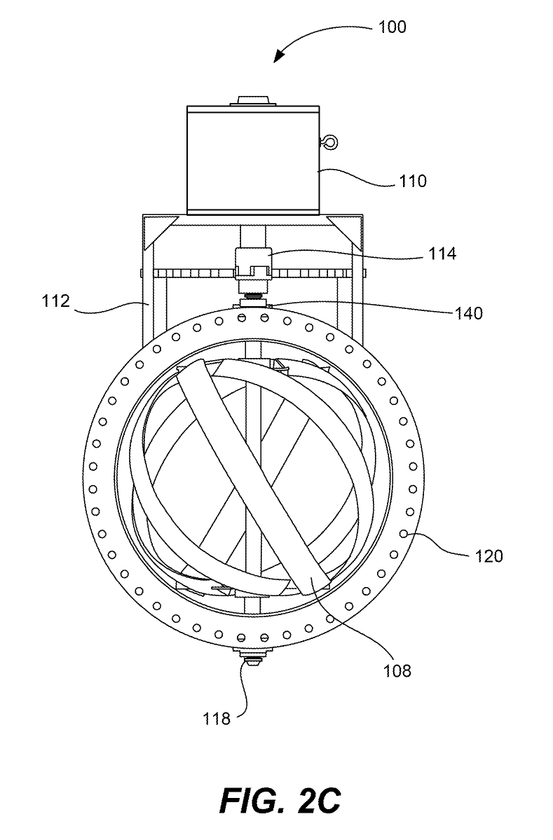

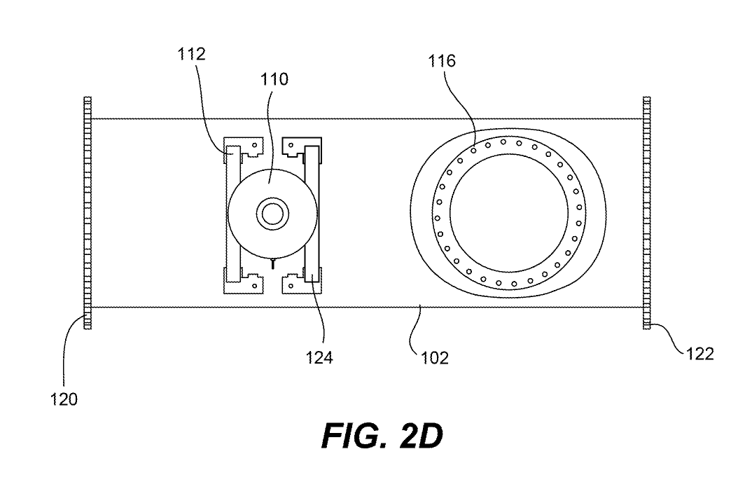

First aperture 104 may have a diameter large enough to receive a shaft of a turbine, which is ultimately inside conduit 50, as explained with respect to FIGS. 2A-2D. By way of example, first aperture 104 has a diameter that is between about 2 inches and about 6 inches and preferably between about 2 inches and about 4 inches. Second aperture 106 may have a diameter that is between about 2 feet and about 3.5 feet, and is preferably between about 2.5 feet and about 3.5 feet. A probe is preferably any one of a human, a motor-driven object or a remotely controlled object. A distance between first aperture 104 and second aperture 106 may be any distance that is large enough such that the presence of a turbine inside the conduit should not prevent a probe from entering through the second aperture. If the distance is too large, then inspection and installation of the turbine, as explained below, can be a time-consuming and an arduous task. In preferred embodiments of the present invention, however, the distance between first aperture 104 and second aperture 106 is between about 2 feet and about 60 feet, and in even more preferred embodiments, the distance between first aperture 104 and second aperture 106 is between about 4 feet and about 10 feet.

In accordance with one preferred embodiment of the present invention, FIG. 1B shows a conduit 60, which is substantially similar to conduit 50 shown in FIG. 1A, except conduit 60 in FIG. 1B includes a third aperture 124 and flanged ends 122 and 120. Third aperture 124 is configured to align with first aperture 104 such that a shaft of a turbine disposed inside conduit 60 passes through both first and third apertures 104 and 124, respectively. Although conduit 60 is designed to provide a flow path for water through an inlet 62 and an outlet 64 ends of conduit 60 are flanged as shown in FIG. 1B. Flanged inlet 120 and flanged outlet 122 allow for connecting conduit 60 to other conduits, which may or may not be configured to receive a turbine. In this manner, a conduit network is created to convey water or a liquid from one point to another.

FIG. 2A shows an in-conduit hydroelectric power generator 100, according to one embodiment of the present invention. According to this figure, a turbine 108 is installed inside a conduit 102. Turbine 108 includes a shaft 118 having a top end and a bottom end. Top end of turbine 108 passes through a first aperture (which is shown in FIGS. 1A and 1B) and bottom end of turbine 108 passes through a third aperture (which is shown in FIG. 1B). After passing through first aperture, top end is secured thereabove using a block 140, a seal 134 and a bearing 126. Similarly, after passing through a third aperture, the bottom end of turbine 108 is secured therebelow using a lower block 130, a lower seal 136 and a lower bearing 132.

A coupling 114 disposed above bearing 126 serves as an interface between shaft 118 of turbine 108 and generator shaft (not shown to simplify illustration) of a generator 110. A generator frame 112 is attached to conduit 102 using a mounting bracket 124 and serves to secure generator 110 to conduit 102. On conduit 102, adjacent to generator 110 and generator frame 112, disposed is a substantially cylindrically-shaped body 138 that protrudes outwardly from second aperture (which is shown in FIGS. 1A and 1B) of conduit 102. A flanged outlet 116 is disposed above the cylindrically-shaped body, as shown in FIG. 2A. Like FIG. 1B, FIG. 2 also shows flanged inlet 120 and flanged outlet 122 which allows conduit 102 to connect to other conduits and form a conduit network, which conveys water or liquid from one point to another. More importantly, in-conduit hydroelectric power generator 100 harnesses hydro-electric power from the flowing action of water through conduit 102.

FIG. 2B shows a perspective view of an in-conduit hydroelectric power generator 100 that is shown in FIG. 2A. FIG. 2C shows clearly an inline view of flow path of water flowing through in-conduit hydroelectric power generator 100 shown in FIG. 2A. FIG. 2D shows a top view of the in-conduit hydroelectric power generator 100 shown in FIG. 2A. In other words, FIGS. 2B, 2C and 2D show from different perspectives, various components assembled and shown in FIG. 2A. By way of example, when water flows through a flow path inside conduit 102, as shown in FIG. 2C, and impinges upon the blades of helical turbine 108, shaft 118 of turbine 108 spins around a central axis, which passes along the length of shaft 118. The spinning action of shaft 118, in turn, causes shaft of generator 110 to spin and generate electricity.

Although first, second and third apertures are not shown in FIGS. 2A-2D to facilitate illustration; they are configured and dimensioned as described with respect to FIG. 1B. Turbine 108 is shown in FIGS. 2A-2D as having a helical design, which is explained in greater detail in U.S. patent application Ser. No. 12/384,765, filed on Apr. 7, 2009 and entitled “In-Pipe Hydro-Electric Power System and Turbine.” It is not necessary that turbine 108 have a spherical design, rather turbines of other designs, such as helical turbine, troposkein turbine, and circular-, square- or rectangular-shaped turbines, work well.

Generator 110 can be any generator that is designed to work in connection with a turbine to produce power. However, in preferred embodiments of the present invention, generator is a permanent magnet three-phase generator. Coupling 114 and blocks 140 and 130 are made from a rigid material, which is preferably made from a material that facilitates a formation of a welded connection to conduit 102. By way of example, in such preferred embodiments of the present invention, coupling consists primarily of intermeshing parts, such as two steel hubs with a more flexible component disposed between them which is capable of flexing slightly in order to compensate for shaft misalignment and transfer torque. Blocks 140 and 130 are preferably made from metal (e.g., steel).

Seals 134 and 136 are made from any material that effectively seals off high pressures encountered at the bottom of third aperture and top of first aperture, respectively. In preferred embodiments of the present invention, these seals are made from either cartridge-type face seal assemblies or radial lip seal assemblies. Bearings 126 and 132 are made from any material that reduces frictional forces acting on shaft 118 when it is rotating. Preferably, however, bearings 126 and 132 are made from a flanged spherical roller bearing assembly.

The present invention also provides a method of assembling an in-conduit hydroelectric power generator 100 shown in FIGS. 2A-2D. In a preferred embodiment, such inventive processes begin by obtaining a cylindrical body, e.g., such as the conduit shown either in FIGS. 1A and 1B, that has defined therein a first aperture and a second aperture. Although such a body can be obtained at a manufacturing site, the present invention allows that such a body and assembly as described herein can be carried out in situ, i.e., at the site of in-conduit network which is designed to harness hydroelectric power. By carrying out the steps of assembling the in-conduit hydroelectric power generator in situ, the present invention circumvents the arduous and time consuming task of assembling such a generator offsite and also obviates the high costs that might be associated with such an assembly process.

Although the present invention contemplates introducing a turbine (e.g., turbine 108 as shown in FIGS. 2A-2D) inside a conduit (e.g., conduit 102 of FIGS. 2A-2D) through an inlet or outlet (e.g., flanged inlet 120 or flanged outlet 122), it is preferable to introduce the turbine, without the shaft, through a second aperture (e.g., aperture 106 of FIGS. 1A and 1B). Next, the turbine, without the shaft, is aligned such that a central axis of the turbine (where a turbine shaft, such as shaft 118 shown in FIGS. 2A, 2C and 2D, is ultimately disposed) passes through the first aperture (e.g., aperture 104 of FIGS. 1A and 1B) and if present, third aperture (e.g., third aperture 124 shown in FIG. 1B). A shaft is then disposed to pass through the first aperture and, if present, the third aperture such that the shaft passes through the central axis of the turbine. In the mating position of the turbine and the turbine shaft, the turbine is secured using bearings, seals and blocks which are positioned behind the first and the third apertures as shown in FIGS. 2A-2D. In such a secured configuration, the turbine assembly is capable of rotational displacement about the central axis of the turbine or turbine shaft, but not capable of lateral displacement.

In one preferred embodiment, the inventive processes include covering the second aperture with a cover. By way of example, the cover is a blind flange that is bolted on to 116 to seal it. During installation, the cover is removed to provide a point of entry inside the conduit as described above Similarly, during an onsite inspection, the same cover is removed to provide access to a probe to inspect the turbine (e.g., spherical turbine, helical turbine, troposkein turbine, and circular-, square- or rectangular-shaped turbines) that is installed inside the conduit.

Inventive assembly processes preferably include steps for providing a generator (e.g., generator 110 above the turbine. By way of example, providing a generator begins with installing a frame assembly (e.g., frame assembly 112 shown in FIGS. 2A-2D). In this step, the frame assembly is mounted on a conduit and disposed above the first aperture as shown in FIGS. 2A-2D. Specifically, the frame assembly is bolted on frame brackets (e.g., frame brackets 124 as shown in FIG. 2B) that are, in turn, preferably attached to the conduit by a welded connection.

Under operation, the liquid or water impinging upon the blades of the turbine causes a turbine shaft to rotate about its axis. A coupling (e.g., coupling 114 shown in FIG. 2A) connection between the turbine shaft (e.g., shaft 118 of FIG. 2A) and shaft of generator (e.g., generator 110 of FIG. 2A) induces the generator shaft to also rotate, producing electricity. The present invention, therefore, provides systems and processes for harnessing energy from the flowing action of water through a conduit.

More importantly, inventive systems and processes which include the provision of a second aperture (e.g., denoted by reference numeral 106 in FIGS. 1A and 1B and that may be covered by flanged outlet) preferably allows for both installation and inspection of the turbine inside the conduit. More importantly, provision of the second aperture allows for both installation and inspection of a turbine assembly.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims

1. A conduit comprising a cylindrical body having defined therein a first aperture and a second aperture, wherein said first aperture is designed to receive a shaft of a turbine and said second aperture is sufficiently large to facilitate ingress or egress of a probe through said second aperture, and wherein said second aperture is located a distance away from said first aperture such that when said shaft of said turbine is disposed through said first aperture, an entry by a probe into said cylindrical body through said second aperture is not prevented by presence of said turbine.

2. The conduit of claim 1, wherein said first aperture has a diameter that is between about 2 inches and about 6 inches.

3. The conduit of claim 2, wherein said first aperture has a diameter that is between about 2 inches and about 4 inches.

4. The conduit of claim 1, wherein said second aperture has a diameter that is between about 2 feet and about 3.5 feet.

5. The conduit of claim 4, wherein said second aperture has a diameter that is between about 2.5 feet and about 3.5 feet.

6. The conduit of claim 1, wherein said probe is a human, a motor-driven object or a remotely controlled object.

7. The conduit of claim 1, wherein said distance between said first aperture and said second aperture is between about 2 feet and about 60 feet.

8. The conduit of claim 7, wherein said distance is between about 4 feet and about 10 feet.

9. The conduit of claim 1, wherein said cylindrical body has a diameter that is between about 2.5 feet and about 10 feet.

10. The conduit of claim 1, further comprising a frame assembly that is mounted on said conduit and disposed above said first aperture, and said frame assembly is designed to secure a generator above said turbine when said turbine is disposed through said first aperture.

11. The conduit of claim 1, wherein said turbine is any one of spherical turbine, helical turbine, troposkein turbine, and circular-, square- or rectangular-shaped turbine.

12. The conduit of claim 1, further comprising a cover which covers said second aperture.

13. The conduit of claim 1, wherein said first aperture is located upstream from said second aperture.

14. The conduit of claim 1, wherein said first aperture is located downstream from said second aperture.

15. The conduit of claim 1, wherein said second aperture is defined by an outlet in a cylindrical body perpendicularly disposed on said conduit and protruding outward and said outlet is a flanged outlet.

16. The conduit of claim 15, further comprising a first block, a first seal, and a first bearing disposed near first aperture to secure said turbine at a first location that is adjacent said first aperture.

17. The conduit of claim 1, further comprising a third aperture disposed opposite to said first aperture such that said shaft of said turbine pass through both said first aperture and said third aperture.

18. The conduit of claim 17, further comprising a second seal, a second bearing and a second block to secure said turbine at a second location that is adjacent said third aperture.

19. The conduit of claim 1, further comprising a generator and a coupling, wherein said coupling serves as an interface between said shaft of said turbine and a shaft of said generator.

20. A method of assembling a conduit capable of generating power, said method comprising:
obtaining a cylindrical body having defined therein a first aperture and a second aperture;
introducing a turbine through said second aperture;
displacing said turbine inside said conduit towards said first aperture such that a central axis of said turbine, which is capable of receiving a shaft, aligns with said first aperture.

21. The method of claim 20, wherein in said obtaining, said second aperture is located a distance away from said first aperture such that an entry by a probe into said cylindrical body through said second aperture is not prevented by presence of said turbine.

22. The method of claim 20, further comprising covering said second aperture with a cover.

23. The method of claim 20, wherein said introducing includes disposing a turbine that is any one of spherical turbine, helical turbine, troposkein turbine, and circular-, square- or rectangular-shaped turbine.

24. The method of claim 20, further comprising installing a frame assembly that is mounted on said conduit and disposed above said first aperture.

25. The method of claim 24, further comprising securing a generator using said frame assembly above said turbine.

26. The method of claim 20, wherein said cylindrical body has defined therein a third aperture and said method further comprising:
passing said shaft of said turbine through said first aperture and said third aperture; and
securing said shaft of said turbine near said first and said third apertures to prevent substantial lateral displacement of said turbine.
